(19) United States
(12) Patent Application Publication
(10) Pub. No.: US 2012/0267896 A1
(43) Pub. Date: Oct. 25, 2012

(54) Network Protection for Power Spot Networks

(75) Inventors: Kevin L. Cousineau, Lompoc, CA (US); Douglas C. Blodgett, Pleasanton, CA (US); William L. Erdman, Orinda, CA (US)

(73) Assignee: Clipper Windpower, Inc., Carpinteria, CA (US)

(21) Appl. No.: 13/090,789

(22) Filed: Apr. 20, 2011

(51) Int. Cl. F03D 9/00; H02H 7/00

(52) U.S. Cl. 290/55; 361/63

(57) ABSTRACT

A power supply system having a spot network is disclosed. The spot network may include first and second power output lines, and first and second accessory power circuits connected in parallel to the first and the second power output lines, respectively. Each of the first and the second accessory power circuits may have a transformer and a circuit breaker connected together to protect the spot network by coordinating impedance of the transformer with trip characteristics of the circuit breaker.

### FIELD OF THE DISCLOSURE

The present disclosure generally relates to spot networks and, more particularly, relates to how currents are managed in a spot network and protection is achieved.

### BACKGROUND OF THE DISCLOSURE

Spot networks are widely used in a variety of applications to provide a reliable power supply to facilities, such as, buildings (e.g., hospitals), power stations and data processing centers. Typically, spot networks operate by connecting two or more transformers in parallel, fed by a high-voltage source to supply one or more loads (e.g., building(s)) connected to a common secondary bus. By virtue of connecting the transformers in parallel, a great degree of reliability is provided to the loads in that a continuous uninterrupted power supply is guaranteed even in the event of a failure of one (or possibly more) transformers within the spot network. This can be achieved primarily because the faulting transformer(s) can be cut off from the spot network and the remaining transformers can take over and continue uninterrupted service to the loads connected on the secondary bus.

In order to ensure that the spot network continues to operate if a transformer in the spot network becomes faulted (e.g., due to any abnormal flow of electric current, such as, a ground fault where one or more phases of the transformer are shorted to ground), each transformer in the spot network is equipped with a network protection device, generally including a circuit breaker and a network power relay. When a transformer becomes faulted, the network power relay of the faulting transformer senses a reverse power flow from the network side (e.g., from the other transformers in the spot network or the secondary bus) towards the primary feeder side and causes its associated circuit breaker to open. Opening the circuit breaker isolates and disconnects the faulted transformer from the spot network while the remaining transformers continue normal operation without any interruption of the power service to the loads. Thus, the redundant nature (provided by multiple transformers connected in parallel) of the spot network ensures that the loads connected to the secondary bus never notice the loss of a transformer and continue to receive uninterrupted power supply.

Later, the faulted transformer is repaired and returned to service and the circuit breaker is closed again to connect the transformer to the secondary bus and allow it to supply current and power again in parallel with the other transformers.

In conventional spot networks, like the one described above, to ensure an uninterrupted power supply to the loads, the network power relay (e.g., an electromechanical or digital protective relay that calculates operating conditions in an electrical circuit and initiates tripping of an associated circuit breaker) of each transformer within the spot network continuously and actively monitors their respective transformers and the direction of power flow through the spot network. Such active sensing and control is complicated, expensive and requires expansive computations to ensure proper operation of the network power relay. It would accordingly be beneficial to achieve the same functionality provided by the network power relay without the associated complexity, expense and without compromising the operational or redundancy benefits of the spot network.

### SUMMARY OF THE DISCLOSURE

In one aspect of the present disclosure, a spot network is disclosed. The spot network may include first and second power output lines and first and second accessory power circuits connected in parallel to the first and the second power output lines, respectively. Each of the first and the second accessory power circuits may have a transformer and a circuit breaker connected together to protect the spot network by coordinating impedance of the transformer with trip characteristics of the circuit breaker.

In another aspect of the present disclosure, an accessory power system is disclosed. The accessory power system may include a wind turbine and a power supply system in operational association with the wind turbine. The power supply system may include (a) a first accessory power circuit having a first transformer; and (b) a second accessory power circuit having a second transformer, a primary side of the first and the second transformers may be connected to first and second power output lines, respectively, and a secondary side of the first and the second transformers may be connected to first and second circuit breakers. The first and the second circuit breakers may be connected to the wind turbine through a common bus to form a spot network. The accessory power system may additionally include a spot network protection system provided by coordinating impedance of the first and the second transformers with trip characteristics of the first and the second circuit breakers, respectively.

In yet another aspect of the present disclosure, a method of protecting a spot network is disclosed. The method may include providing (a) first and second transformers within first and second accessory power circuits, respectively, connected in a spot network; and (b) first and second circuit breakers connected to the first and the second transformers, respectively. The method may additionally include coordinating impedance of the first transformer with trip characteristics of the first circuit breaker; coordinating impedance of the second transformer with trip characteristics of the second circuit breaker; and protecting the spot network by using only the first and the second transformers and the first and the second circuit breakers.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a circuit diagram of a first embodiment of a power supply system, in accordance with at least some embodiments of the present disclosure;

FIG. 2 is a circuit diagram of a second embodiment of the power supply system of FIG. 1, in accordance with at least some other embodiments of the present disclosure;

FIG. 3 is a circuit diagram showing portions of the power supply systems of FIGS. 1 and 2 in greater detail;

FIG. 4 is a schematic diagram showing the power supply systems of FIGS. 1 and 2 employed in conjunction with a wind turbine, in accordance with at least some embodiments of the present disclosure;

FIG. 5 is a flowchart showing a method of operation of the power supply systems of FIGS. 1 and 2, in accordance with at least some embodiments of the present disclosure; and

FIG. 6 shows an exemplary graph depicting the operating characteristics of a circuit breaker.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

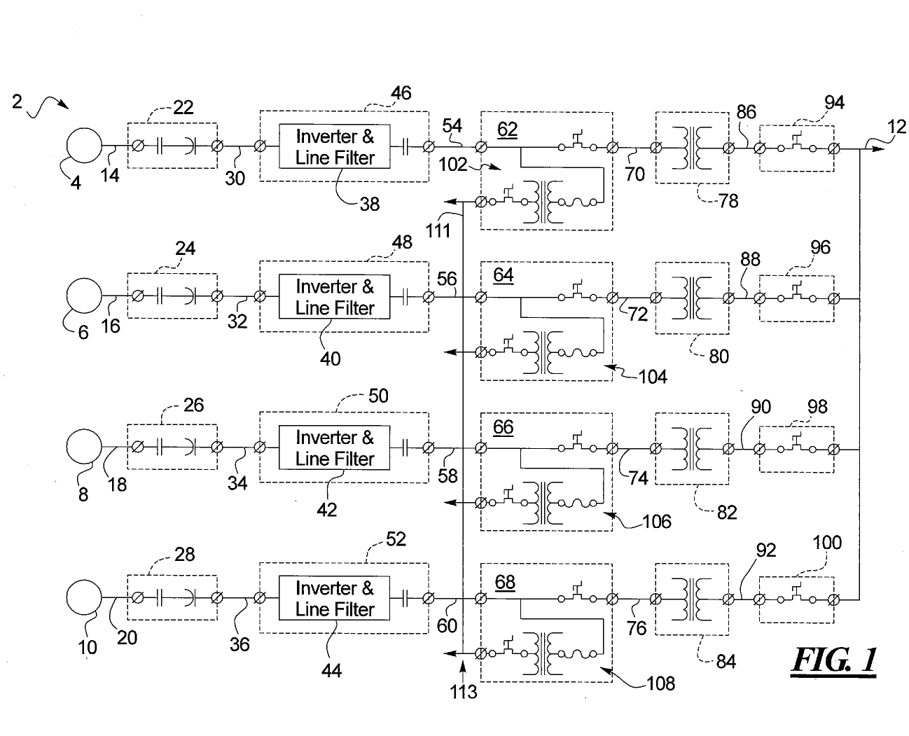

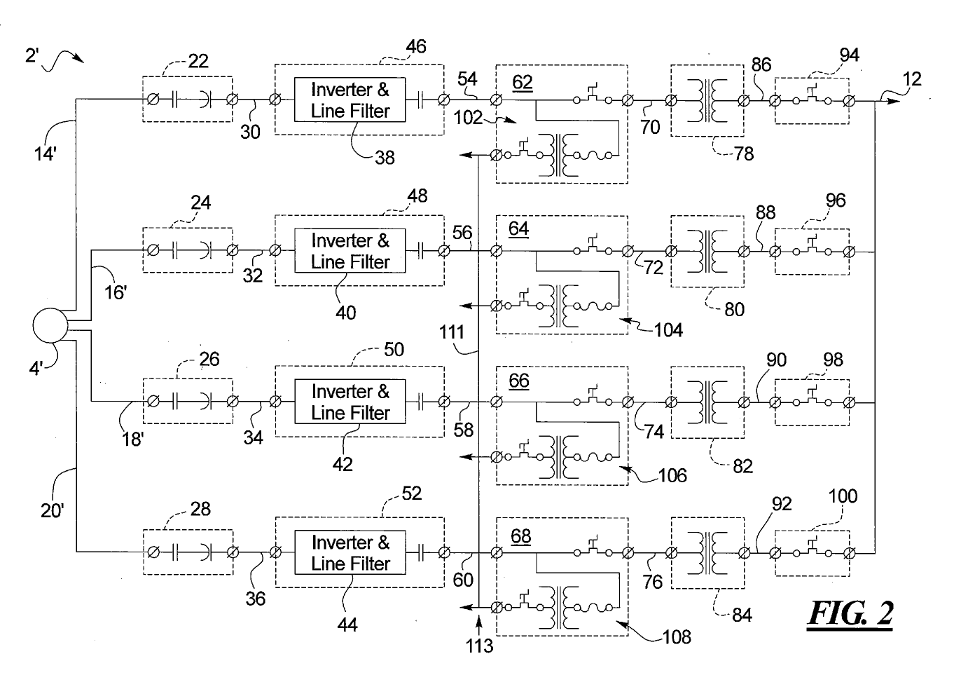

Referring to FIG. 1, a simplified circuit diagram of a power supply system 2 is shown, in accordance with at least some embodiments of the present disclosure. As shown, the power supply system 2 may include first, second, third and fourth power generators (also referred to herein as electrical generators) 4, 6, 8 and 10, respectively, which supply electric power to a utility connection 12 via a parallel transformer network of a series of rectifiers, inverters, power distribution panels, utility transformers and switchgears, as described in greater detail below. Notwithstanding the fact that in the present embodiment, four power generators 4-10 have been shown, it will be understood that this is merely exemplary. In other embodiments, more than four power generators or, alternatively, less than four or even a single power generator, as shown in FIG. 2, may be utilized within the power supply system 2.

Each of the power generators 4-10 may be designed to receive mechanical energy from an external energy source (not shown) and convert that energy into alternating current (AC) electrical energy. The external energy source supplying mechanical energy to the power generators 4-10 may be any of a wide variety of sources, such as, wind energy, hydraulic energy, tidal/wave/ocean thermal energy, geothermal energy, biogas/biomass energy, internal combustion engines, compressed air, etc. Alternatively, the generators 4-10 may include solar cells, fuel cells and the like. The electric current generated by the power generators 4-10 may be transferred along four parallel output paths (or output windings) 14, 16, 18 and 20, to respective rectifiers 22, 24, 26 and 28.

The rectifiers 22-28 may convert the AC current received from the power generators 4-10 into a direct current (DC) for transmission to another location, such as a receiving station. By virtue of transmitting current in the form of a DC current, especially during long distance transmissions, electrical losses during transmission may be minimized. The DC current generated by the rectifiers 22-28 may be then transmitted along DC output lines 30, 32, 34 and 36, respectively, to respective inverters 38, 40, 42 and 44 at the receiving station. Each of the inverters 38-44 may convert the DC current received from the rectifiers 22-28 back into AC current for further transmission and distribution. Each of the inverters 38-44 may additionally employ one or more filters and other components to improve the quality of the output current by limiting passage of any harmonic components.

Furthermore, the inverters 38-44 may be controlled by respective generator control units (GCU) 46, 48, 50 and 52. In particular, depending upon power load transitions (low load to high load and vice versa) at the utility connection 12, the GCUs 46-52 may modulate their respective inverters 38-44 to generate a required AC current to meet load demands. Although not shown, it will be understood that each of the GCUs 46-52 may receive several types of inputs, such as, grid voltage, power load demands, temperature ratings etc., from various components within the power supply system 2 to compensate and modulate their respective inverters 38-44 to generate varying AC output currents.

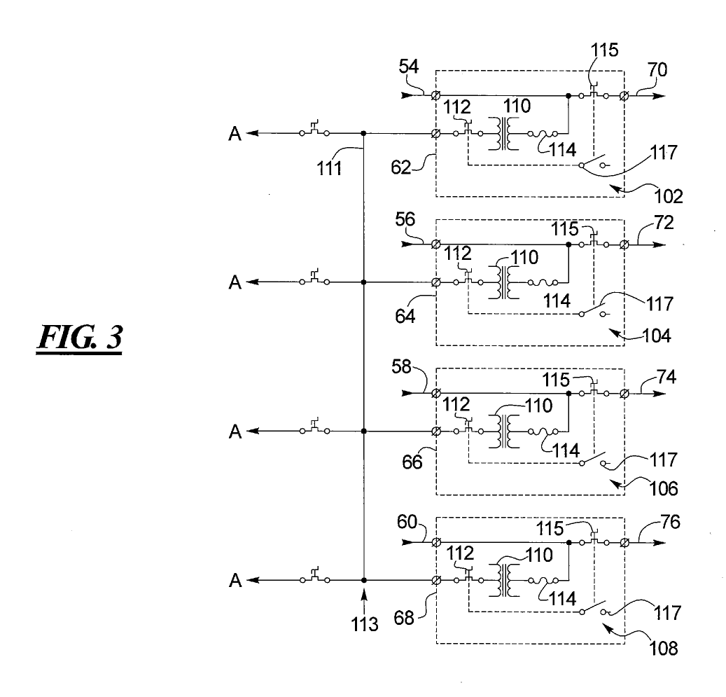

The AC output current generated by the respective inverters 38-42 may then be transmitted along AC output lines 54, 56, 58 and 60, to power distribution panels (PDP) 62, 64, 66 and 68, respectively. The PDPs 62-68 may distribute the incoming power via transmitting lines 70, 72, 74 and 76 to utility transformers 78, 80, 82 and 84, respectively, which in turn may supply the utility connection 12 and various loads (not shown) connected to the utility connection through lines 86, 88, 90 and 92 and switchgear 94, 96, 98 and 100. In addition to transmitting current towards the utility connection 12, each of the PDPs 62-68 may also provide accessory (or operating) power via respective accessory power circuits 102, 104, 106 and 108. The accessory power circuits 102-108 are described in greater detail in FIG. 3 below.

Referring now to FIG. 2, another embodiment 2′ of the power supply system 2 is shown, in accordance with at least some other embodiments of the present disclosure. To the extent that the power supply system 2′ is substantially similar to the power supply system 2, only the differences between the two systems will be discussed here for conciseness of expression. In contrast to the power supply system 2, which includes four power generators 4-10, the power supply system 2′ includes only a single generator 4′ that provides AC output current along output paths 14′, 16′, 18′ and 20′, each of which is a winding of the generator 4′. Notwithstanding the fact that the generator 4′ is shown with four output windings, it will be understood that this is merely exemplary. In other embodiments, the power generator 4′ may have less than or greater than four windings, depending upon the requirements of the loads at the utility connection 12, as well as the level of redundancy needed for the accessory power circuits 102-108.

Each of the output paths 14′-20′ constitute a power path, similar to the output paths 14-20 and deliver AC current from the power generator 4′ to the respective inverters 38-44 through the rectifiers, 22-28, respectively, and continue the same path through the PDPs 62-68, the utility transformers 78-84 and the switch gears 94-100 described above with respect to FIG. 1. Further, similar to the power supply system 2, the power supply system 2′ may also include multiple accessory power circuits 102-108 within the respective PDPs 62-68, which are described in greater detail in FIG. 3.

Turning now to FIG. 3, and referring to it in conjunction with FIGS. 1 and 2, each of the accessory power circuits 102-108 may include a respective transformer 110. A secondary side of each of the transformers 110 may be connected to a common (or secondary) bus 111 via a respective circuit breaker 112, while a primary side of those transformers may be connected to the AC output lines 54-60 via a respective fuse 114. By virtue of being connected in parallel and additionally being connected to the common bus 111, the transformers 110 of the accessory power circuits 102-108 constitute a spot network 113, which energizes and provides accessory power from the generators 4-10 (or the generator 4′) to one or more loads “A” connected to the common bus 111.

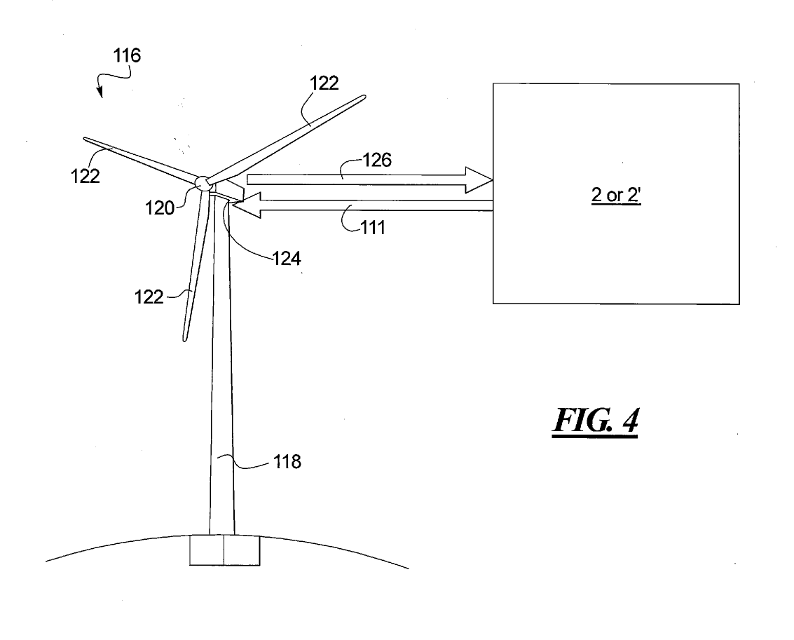

One example of the load(s) “A” that may benefit from the accessory power provided by the accessory power circuits 102-108 may be a wind turbine shown in FIG. 4. In particular and with respect to a wind turbine load, the accessory power circuits 102-108 may be employed for providing power to various ancillary electrical components of the wind turbine, such as, yaw drive motors, cooling fan motors, rotor-blade pitch motors, sensors, computers, etc., that are employed for the proper operation of the wind turbine. By virtue of connecting the accessory power circuits 102-108 in the spot network 113 and providing accessory power to the wind turbine through the spot network, a continuous and uninterrupted power supply to the wind turbine to generate power may be ensured, even in the event of a fault in one or more of the transformers 110. It will be understood that the wind turbine ancillary components are merely one example of the load(s) “A” that may benefit from the spot network 113. The disclosure and benefits rendered by the spot network 113 are equally applicable to other components and power systems.

Normally, with each of the transformers 110 in parallel, a fault in any one of the transformers may cause all the circuit breakers 112 to trip or otherwise open, which in turn may cause all the transformers to disconnect, thereby leaving the wind turbine down and off-line. The spot network 113, in contrast, is configured to provide a redundancy benefit such that a fault in one of the transformers 110 may not cause the other transformers to fail, which continue normal operation, as described above, to ensure that the wind turbine ancillary components or other components stay online. A transformer fault may occur due to any abnormal flow of current. Some example of faults may include a short circuit fault, in which the current flow may bypass a normal load. In a poly-phase system, a fault may involve one or more phases and ground, or may occur only between phases. In a “ground fault” or “earth fault”, current may flow into the Earth, for example, due to lightning.

In the event of a transformer fault (e.g., in the transformer 110 of the accessory power circuit 102), the circuit breaker 112 associated with that transformer may trip and isolate that transformer from the spot network 113, while the remaining transformers of the accessory power circuits 104-108 may remain unaffected and continue to provide uninterrupted power supply to the wind turbine. In order to ensure proper operation of the circuit breaker 112 such that the circuit breaker trips only when a fault occurs in its associated transformer 110 and does not trip in case of a fault in a neighboring transformer, each of the transformers 110 may be designed with a particular impedance characteristic.

In general, the impedance of a transformer may be defined as the voltage drop across the windings of the transformer on full load due to the winding resistance and leakage reactance and, it is typically expressed as a percentage of the rated voltage. The impedance of a transformer may have an effect on system fault levels insofar as it may determine the maximum value of current that can flow under fault conditions. Thus, by employing transformers having a particular impedance rating and associating those transformers with circuit breakers capable of tripping upon detecting the maximum fault current flow through their respective transformers, the transformers may be automatically and selectively isolated from a network without the use of typical transducers (e.g., network relays) and other control systems.

For example, in at least some embodiments, the transformers 110 may be selected to have an impedance rating of 10% or higher, which may determine the maximum fault current that may flow through those transformers. The circuit breakers 112 associated with the transformers 110 having 10% impedance may be selected (or specified) to trip only after detecting at least the maximum fault current. Thus, when a fault occurs at one of the transformers 110 (e.g., say a fault occurs at the transformer 110 of the accessory power circuit 102), a reverse (or back-feed) current from the other non-faulting transformers of the accessory power circuits 104-108 may flow towards the faulted transformer of the accessory power circuit 102, thereby increasing the current at the faulting transformer by up to three times (3×) the maximum fault current rating. Such a high current may cause the circuit breaker 112 of the accessory power circuit 102 to enter an instantaneous tripping curve, which may cause the circuit breaker to trip instantaneously without any intentional time delay. In this manner, the circuit breaker 112 may detect a fault condition in its associated transformer 110 and interrupt continuity to immediately discontinue electrical flow to that transformer.

In addition to experiencing a 3× reverse current flow at the faulted transformer 110 of the accessory power circuit 102, the remaining transformers of the accessory power circuits 104-108 also experience an increased current flow. Particularly, when one of the transformers 110 (e.g., the transformer 110 in the accessory power circuit 102) in the spot network 113 faults, only that transformer's current into the spot network is reversed in direction. The other three non-faulting transformers 110 (e.g., the transformers of the power accessory circuits 104-108) experience high (non-reversing) current into the spot network 113, that is limited by the transformer impedance, described above. However, the increased current flow experienced by those non-faulting transformers is only about one third of the maximum fault current rating. Thus, the increased current flow may cause a brief surge in current beyond the normal current flow through the non-faulting transformers 110, but the circuit breakers 112 associated with those transformers may be specified or selected to not trip. Rather, the circuit breakers 112 of the non-faulting transformers 110 may enter a delayed tripping curve, which may permit brief current surges up to or near the maximum fault current for a small period of time (grace period) before tripping. Within this grace period, the circuit breaker 112 of the faulted transformer 110 trips and disconnects the faulted transformer. Once the faulted transformer 110 is disconnected, the flow of reverse current stops, and the brief surge of current at the non-faulting transformers 110 ends as well, thereby preventing the circuit breakers 112 of the non-faulting transformers to trip.

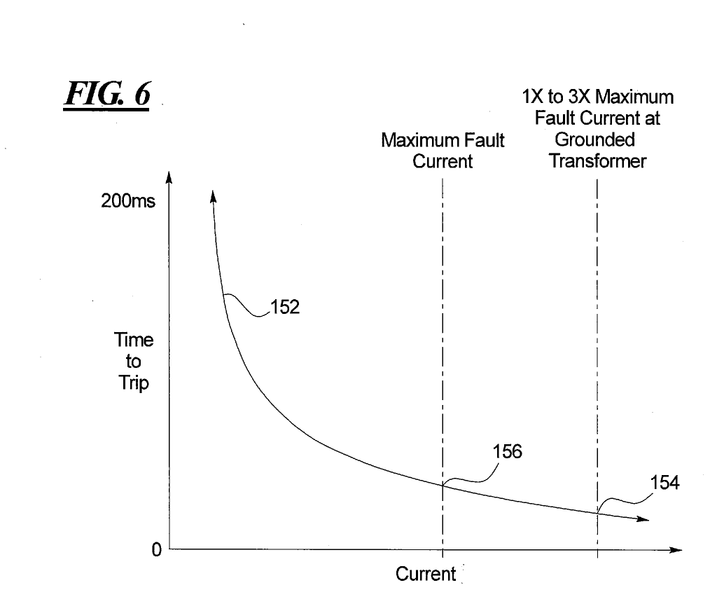

The aforementioned trip characteristics of the circuit breakers 112 may be better understood by reference to FIG. 6. Specifically, FIG. 6 is a graph, an X-axis of which represents current, a Y-axis of which represents a time to trip for the circuit breakers 112 and a curve 152 of which represents the operating characteristics of those circuit breakers. As shown, as the current along the X-axis increases, the time required for the circuit breakers 112 to trip decreases. At a point 154, which represents a 1× to 3× of the maximum fault current rating, the circuit breakers 112 may be designed or specified to enter the aforementioned instantaneous tripping curve and trip instantaneously (e.g., when the faulted transformer 110 experiences a current flow equivalent to 1×-3× of the maximum fault current rating). On the other hand, up to a point 156 on the graph, the circuit breakers 112 may enter the aforementioned delayed tripping curve, at which the circuit breakers experience a surge in current flow (such as that experienced by the non-faulting transformers 110 when a fault occurs at one of the transformers), and may take a longer time to trip compared with the time to trip at the point 154. Accordingly, the point 156 may represent a delayed tripping period, which provides the above grace period to the circuit breakers 112 to disconnect their associated faulted transformer 110.

Thus, by virtue of designing or selecting the transformers 110 with a specific impedance characteristic and coordinating that impedance with the trip characteristics of their respective circuit breakers 112, as described above, a fault in one of the transformers in the spot network 113 may only result in that transformer from being removed from the spot network while leaving the other transformers to continue normal operation. Furthermore, by designing the transformers 110 with a particular impedance (such as that described above), the necessity of employing an expensive and complex network power relay to protect the spot network 113 may be avoided and the spot network 113 may be protected without the need to continuously monitor the spot network and by using only the components that are typically present in the spot network.

In addition to disconnecting the accessory power circuits 102-108 from the spot network in the event of a fault at one of the transformers 110 of those circuits, the present disclosure also provides a provision for disconnecting the accessory power circuits when faults occur on the primary side of the transformers 110 or when maintenance work on the primary side of the transformers may be needed. This may be provided by employing spare contacts 117, which connect circuit breakers 115 on the AC output lines 54-60, respectively to the circuit breakers 112 of the accessory power circuits 102-108. When any of the circuit breakers 115 open, they in turn cause their associated spare contacts 117 to open, which open the associated circuit breaker 112. The open circuit breaker 112 then disconnects its associated transformer 110, in a manner described above. When the circuit breaker 115 re-closes, the circuit breaker 112 re-closes, thereby restoring participation of the disconnected transformer 110 within the spot network 113.

Notwithstanding the fact that in the present embodiment, the transformers 110 have been described as having an impedance rating of 10%, it will be understood that this is merely exemplary. In other embodiments, depending upon the size of the transformers 110, as well as the distribution cabling involved and the power requirements of the load(s) “A,” the impedance rating of the transformers may vary and the size of the circuit breakers 112 may vary correspondingly.

Turning now to FIG. 4, an exemplary wind turbine 116 in association with the power supply system 2 or 2′ is shown, in accordance with at least some embodiments of the present disclosure. While all the components of the wind turbine have not been shown in FIG. 4, a typical wind turbine may include a tower 118 and a rotor 120. The rotor 120 may include a plurality of blades 122, which rotate with wind energy and transfer that energy to a main shaft situated within a nacelle 124. The nacelle 124 may additionally include a low-speed shaft driven by the main shaft, a gearbox connecting the low speed shaft to a high speed shaft and one or more generators driven by the high speed shaft to generate electric current.

In at least some embodiments, the power generators 4-10 (or the power generator 4′) described above may be situated within the nacelle 124, although in other embodiments, and as shown, those power generator(s) may be situated outside the nacelle. Thus, the wind turbine 116 may harness wind energy and transfer that energy via lines 126 to the power generators 4-10 (or the power generator 4′), which may convert the wind energy into electrical energy. The electrical energy may then be transmitted and distributed via the power supply system 2 or 2′, described above to deliver power to the utility connection 12.

In addition to supplying power to the utility connection 12 and, as discussed above, the wind turbine 116 may require power itself to function and operate some of its components, such as, yaw drive (not shown) for changing the face of the blades 122 to face the direction of the wind, a speed sensor (also not shown) for sending the speed of rotation of the blades, etc. These components may be connected as the loads “A” to the common bus 111 and receive power through the spot network 113 of the accessory power circuits 102-108, in a manner described above. As also mentioned above, by connecting the wind turbine 116 to the accessory power circuits 102-108 through the spot network 113, an uninterrupted power supply may be guaranteed to the wind turbine, thereby minimizing the risk of the wind turbine going off-line and stopping power generation. Furthermore, although only a single wind turbine 116 has been shown in relation with the power supply system 2 and 2′, in at least some embodiments, several wind turbines, or even a complete wind turbine farm may be connected to and receive accessory power from the power supply systems described above.

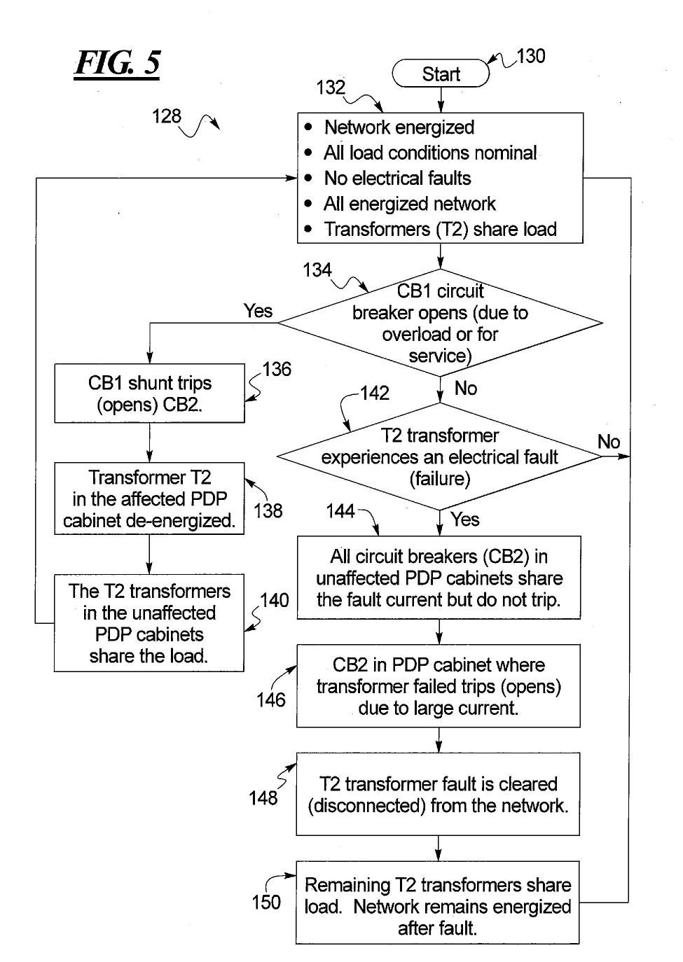

Referring now to FIG. 5, a flowchart 128 describing the steps of operation of the spot network 113 and particularly, the steps of protecting the spot network from any fault within the power supply systems 2 and 2′ is shown, in accordance with at least some embodiments of the present disclosure. After starting at a step 130, the process proceeds to a step 132, where if the power supply systems 2 and 2′ are working normally, the transformers 110 of the accessory power circuits 102-108 share the loads “A” connected to the common bus 111 through the spot network 113. Normal operation of the power supply systems 2 and 2′ may be defined at least by determining whether the spot network 113 is energized or not, whether the load conditions are nominal and whether any electrical faults have been detected at any of the transformers 110. If the power supply systems 2 and 2′ are indeed functioning under normal conditions, that is, the spot network 113 is energized, the loads are nominal and no electric faults have been detected, then, at a step 134, it is determined whether any of the circuit breakers 115 associated with each of the accessory power circuits 102-108 is open or not. The circuit breaker 115 may open automatically due to any electrical faults (such as overloads) on the primary side of the transformers 110, or alternatively, it may be opened by manual operation for any servicing or maintenance of the power supply system 2 or 2′ on the primary side of the transformers.

If any of the circuit breakers 115 is open, then at a step 136, the circuit breaker 112 associated with the circuit breaker 115 trips and opens, which in turn, at a step 138, isolates its associated transformer 110 from the spot network 113 to prevent any damage thereto, as well as to the remaining transformers within the spot network. After disconnecting the transformer 110 associated with the open circuit breakers 112 and 115, the remaining transformers of the accessory power circuits 102-108 continue operation uninterrupted to share and provide accessory power to the loads “A” at a step 140. When the circuit breaker 115 recloses (either closed manually at the end of maintenance or automatically due to the fault being fixed), it instructs its circuit breaker 112 to reclose as well and the transformer 110 associated with those circuit breakers may be energized again to participate in the spot network 113 and the process loops back to the step 132.

On the other hand, if at the step 134 it was determined that the circuit breaker 115 was not open, then the process proceeds to a step 142. At the step 142, it is determined whether during the course of normal operation of the spot network 113, a fault in any of the transformers 110 of the accessory power circuits 102-108 is detected. If no fault is detected, then the process loops back to the step 132 and the power supply systems 2 and 2′ continue to operate under normal conditions. However, if a fault in any of the transformers 110 (for example, fault in the transformer 110 of the accessory power circuit 102) is indeed detected at the step 142, then at a step 144, a large reverse current starts flowing through the faulted transformers 110 while a large (non-reverse) current flows through the non-faulting transformers. However, as discussed above, due to the impedance characteristics of the transformers 110, the non-faulting transformers (e.g., the transformers at the accessory power circuits 104-108) do not disconnect from the spot network 113, primarily because their associated circuit breakers 112 experience only one third of the total fault current and do not trip due to the delayed tripping curve of those circuit breakers.

However, at a step 146, the circuit breaker 112 associated with the faulted transformer 110 (e.g., transformer at the accessory power circuit 102) detects a large fault current equivalent to three times that of the maximum fault current rating and trips immediately and opens due to that circuit breaker operating in its instantaneous tripping curve. As soon as the circuit breaker 112 of the faulting transformer 110 is opened, that faulted transformer (of the accessory power circuit 102) is cleared (or disconnected) from the spot network 113 at a step 148, while the remaining transformers (of the accessory power circuits 104-108) remain energized and share the loads “A” at a step 150 and continue operation in accordance with the step 132.

Notwithstanding the description of the power supply systems 2 and 2′ above, it will be understood that the configuration of those power supply systems, as well as the electrical configuration of the various components employed therein may vary, depending particularly upon the application of the power supply systems, the loads serviced by the power supply systems, the distance between the power generation station and the location of the loads (at the utility connection or otherwise the accessory power loads), as well as the distribution cabling employed. For example, in at least some embodiments, each of the power generators 4-10 may be any of a variety of alternating current (AC) electric generators including, electromagnetic generators employing permanent magnets or field windings and generating single phase or poly-phase power. Further, each of those generators may be portable, stand-by, or other type of generators.

Similarly, although each of the rectifiers 22-28 described above has been shown to have only a cell and a diode, this depiction is merely exemplary. Each of the rectifiers 22-28 may have several diodes and several other components that are commonly employed in the construction of electrical rectifiers. Furthermore, each of the rectifiers 22-28 may be any of a variety of rectifiers that are commonly employed in power supply systems including, for example, bridge rectifiers, and each rectifier may additionally employ filters and other components for smoothing and improving the quality of the rectifier output current. Each of the rectifiers 22-28 may also be an active rectifier having a bridge configuration of switched transistors (e.g., bipolar, insulated-gate bipolar transistor (IGBT), or metal-oxide-semiconductor field-effect transistor (MOSFET)) or silicon controlled rectifiers (e.g., SCR's) or other type of thyristor switching circuits.

Relatedly, the type, configuration and components employed within each of the inverters 38-44, the GCUs 46-52, the PDPs 62-68, utility transformers 78-84 and the switchgear 94-100 may vary in other embodiments and although they have not been shown or described in great detail, each of those components are intended to operate in a manner that is commonly known in power supply systems. Furthermore, depending upon the positioning of various transformers within the power supply system, each of the transformers may be either a step-down or a step-up transformer and the number of windings in each of the transformer may vary as well.

Moreover, it will be understood that the power supply system 2 has been shown in a simplified form and that, several other components, which are typically present and employed in conventional power generation, transmission and distribution systems, may be employed within the power supply system. Furthermore, each of the components described above may be part of a single power generating/transmitting/distributing station, or alternatively, may be part of several stations spanning long distances and/or several geographical regions. In addition, the presence of all the components described above is also not mandatory. For example, in at least some embodiments, wherein long transmissions of current are not required, the use of the rectifiers 14-20 may be entirely skipped or be replaced by other components and devices. Also, although four parallel transformer networks have been shown in the present disclosure, this is merely for explanation purposes. In other embodiments, less than or more than four parallel networks may be present in the power supply system 2.

Furthermore, although the above disclosure has been provided with respect to power supply systems, it will be appreciated that the teachings of the present disclosure may be applied to other applications as well. In general, it is an intention to employ the above disclosure with spot networks in any application where protection of the spot network is desired.

### INDUSTRIAL APPLICABILITY

In general, the present disclosure sets forth a spot network for supplying accessory power. The spot network may effectively parallel several transformers and provide a spot network protection mechanism such that a fault in one accessory power circuit (e.g., fault in the transformer of the accessory power circuit) may not result in a fault in the other accessory power circuits, thereby increasing reliability of the loads (e.g., wind turbine) connected to the spot network. By employing high impedance transformers within each of the accessory power circuits and coordinating the circuit breaker trip characteristics with their respective transformers, an effective spot network protection mechanism may be provided, such that a circuit breaker opens only in case of a fault in its transformer while it does not open in the event of a fault in a neighboring transformer.

Thus, spot network protection may be provided using the same components that are conventionally employed within spot networks, without adding any additional components and even removing the need to use an expensive and complex network power relay that is traditionally used to protect spot networks. By virtue of removing the network power relay, the present disclosure avoids any active and continuous monitoring of the current direction within the network to protect the spot network from reverse current flow faults while still providing the redundancy benefits of the spot network.

While only certain embodiments have been set forth, alternatives and modifications will be apparent from the above description to those skilled in the art. These and other alternatives are considered equivalents and within the spirit and scope of this disclosure and the appended claims.

We claim:

1. A spot network, comprising:
first and second power output lines; and
first and second accessory power circuits connected in parallel to the first and the second power output lines, respectively, each of the first and the second accessory power circuits having a transformer and a circuit breaker connected together to protect the spot network by coordinating impedance of the transformer with trip characteristics of the circuit breaker.

2. The spot network of claim 1, wherein the first and the second power output lines are output lines from first and second power generators, respectively.

3. The spot network of claim 1, wherein the first and the second power output lines are first and second windings, respectively, of a single power generator.

4. The spot network of claim 1, wherein each of the first and the second accessory power circuits is part of a respective power distribution panel.

5. The spot network of claim 1, wherein the spot network is protected only by coordinating the impedance of the transformer with the trip characteristics of the circuit breaker without the use of any power network relays or transducers.

6. The spot network of claim 1, wherein the impedance of the transformers of the first and the second accessory power circuits is at least 10 percent.

7. The spot network of claim 1, wherein a faulted one of the transformers of the first and the second accessory power circuits causes a three times a maximum fault current rating to flow through the faulted one of the transformers and only a one third of the maximum fault current rating to flow through a non-faulting one of the transformers of the first and the second accessory power circuits.

8. The spot network of claim 7, wherein the circuit breaker associated with the faulted one of the transformers enters an instantaneous tripping curve to trip instantaneously disconnect the faulted one of the transformers from the spot network, while the circuit breaker associated with the non-faulting one of the transformers enters a delayed tripping curve to prevent the non-faulting one of the transformers from disconnecting from the spot network.

9. The spot network of claim 1, wherein the circuit breakers of the first and the second accessory power circuits are selected to trip during a fault in their associated transformer and not trip during a fault in a neighboring transformer to provide uninterrupted accessory power.

10. An accessory power system, the system comprising:
a wind turbine;
a power supply system in operational association with the wind turbine, the power supply system having (a) a first accessory power circuit having a first transformer; and (b) a second accessory power circuit having a second transformer, a primary side of the first and the second transformers connected to first and second power output lines, respectively, and a secondary side of the first and the second transformers connected to first and second circuit breakers, the first and second circuit breakers connected to the wind turbine through a common bus to form a spot network; and
a spot network protection system provided by coordinating impedance of the first and the second transformers with trip characteristics of the first and the second circuit breakers, respectively.

11. The accessory power system of claim 10, wherein the first and the second transformers are selected with impedance of at least 10%.

12. The accessory power system of claim 10, wherein the first and the second circuit breakers enter an instantaneous tripping curve upon sensing a three times a maximum fault current rating and trip instantaneously.

13. The accessory power system of claim 10, wherein the first and the second circuit breakers enter a delayed tripping curve upon sensing a surge of current up to or near a maximum fault current rating and do not trip instantaneously.

14. The accessory power system of claim 10, wherein the first or the second circuit breakers associated with a faulted one of the first or the second transformers trips while the first or the second circuit breakers associated with a non-faulting one of the first or the second transformers does not trip.

15. A method of protecting a spot network, the method comprising:
providing (a) first and second transformers within first and second accessory power circuits, respectively, connected in a spot network, (b) first and second circuit breakers connected to the first and the second transformers, respectively;
coordinating impedance of the first transformer with trip characteristics of the first circuit breaker;
coordinating impedance of the second transformer with trip characteristics of the second circuit breaker; and
protecting the spot network by using only the first and the second transformers and the first and the second circuit breakers.

16. The method of claim 15, wherein protecting the spot network comprises:
tripping the first or the second circuit breakers associated with a faulted one of the first or the second transformers; and
disconnecting the faulted one of the first or the second transformers from the spot network.

17. The method of claim 16, wherein tripping the first or the second circuit breaker comprises:
flowing a three times a maximum reverse fault current rating through the faulted one of the first or the second transformers.

18. The method of claim 17, wherein flowing a three times a maximum fault current further comprises:
flowing a one third of the maximum non-reverse fault current through a non-faulting one of the first or the second transformers.

19. The method of claim 16, wherein protecting the spot network further comprises:
delaying the tripping of the first or the second circuit breakers associated with a non-faulting one of the first or the second transformers.

20. The method of claim 15, wherein providing the first and the second transformers comprises:
selecting the first and the second transformers with impedance of at least 10%.
